(19) United States
(12) Patent Application Publication
(10) Pub. No.: US 2009/0010283 A1
(43) Pub. Date: Jan. 8, 2009

(54) Synchronization method of electronic apparatuses

(75) Inventors: Cheng-Ru Lin, Taipei City (TW); Cheng-Yue Chang, Taipei County (TW); Jeng-Chun Chen, Taipei City (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/822,259

(22) Filed: Jul. 3, 2007

(51) Int. Cl. H04J 3/06

(52) U.S. Cl. 370/508

(57) ABSTRACT

A synchronization method is cooperated with a master apparatus and a plurality of slave apparatuses. The synchronization method includes at least a transmitting process, at least a responding process, at least a receiving process, a calculating process and a time-adjusting process. The transmitting process is for transmitting a synchronization message to at least one of the slave apparatuses through a network and recording a transmitting time by the master apparatus. The responding process is for transmitting a responding message to the master apparatus through the network and record a responding time after the slave apparatus receives the synchronization message. The receiving process is for receiving the responding message and recording a receiving time by the master apparatus. The calculating process is for calculating a time-adjusted amount by the master apparatus according to at least one set of the transmitting time, the responding time and the receiving time derived from the transmitting process, the responding process and the receiving process. The time-adjusting process is for transmitting the time-adjusted amount to the slave apparatus by the master apparatus and adjusting the time clock according to the time-adjusted amount by the slave apparatus.

### BACKGROUND OF THE INVENTION

1. Field of Invention

The invention relates to a synchronization method and, in particular, to a synchronization method of electronic apparatuses.

2. Related Art

By the improvements of technologies, a variety of electronic apparatuses are developed. In particular, the electronic apparatuses used to play media data, such as DVD players, speakers or LCDs, etc., are indispensable in our daily life. In addition, due to the developed and widespread networks, digital home has already become a new living style. In the digital home environment, the foregoing electronic apparatuses used to play media data are connected to each other by a wired or wireless network.

After the electronic apparatuses are connected to each other through the network, they can operate together with their own functions. For example, the DVD player outputs audio-video data, the speakers play audio data, and the LCD display video data. Thus, users can enjoy the media environment built by the electronic apparatuses.

However, when the electronic apparatuses play the data, the synchronization therebetween is hardly achieved. When the electronic apparatuses can not be synchronized, the playing efficiency thereof may be lowered greatly. The problem of synchronization can be resorted to many reasons, such as the delay of network transmission, the buffer control algorithm of protocols, or the differences between the crystal oscillators in the electronic apparatuses. The problem of synchronization will become more serious while there are more electronic apparatuses connected.

Therefore, it is an important subject to provide a synchronization method, which can achieve and maintain the synchronization between the electronic apparatuses, further enhancing playing efficiency.

### SUMMARY OF THE INVENTION

In view of foregoing, the invention is to provide a synchronization method, which can achieve and maintain the synchronization between the electronic apparatuses, further enhancing playing efficiency.

To achieve the above, a synchronization method is cooperated with a master apparatus and a plurality of slave apparatuses. The synchronization method includes at least a transmitting process, at least a responding process, at least a receiving process, a calculating process and a time-adjusting process. The transmitting process is for transmitting a synchronization message to at least one of the slave apparatuses through a network and recording a transmitting time by the master apparatus. The responding process is for transmitting a responding message to the master apparatus through the network and record a responding time after the slave apparatus receives the synchronization message. The receiving process is for receiving the responding message and recording a receiving time by the master apparatus. The calculating process is for calculating a time-adjusted amount by the master apparatus according to at least one set of the transmitting time, the responding time and the receiving time derived from the transmitting process, the responding process and the receiving process. The time-adjusting process is for transmitting the time-adjusted amount to the slave apparatus by the master apparatus and adjusting the time clock according to the time-adjusted amount by the slave apparatus.

As mentioned above, the synchronization method according to the invention is to calculate a time-adjusted amount according to at least one set of transmitting time, responding time and receiving time derived from the transmitting process, responding process and receiving process. Thus, the slave apparatus can adjust its time clock to be the same as that of the master apparatus according to the time-adjusted amount, so that the synchronization between the master apparatus and the slave apparatuses can be achieved. The synchronization method of the invention can be utilized in conjunction with the master apparatus and slave apparatuses so as to achieve the desired synchronization, further enhancing the playing efficiency.

### BRIEF DESCRIPTION OF THE DRAWINGS

The invention will become more fully understood from the detailed description given herein below illustration only, and thus is not limitative of the present invention, and wherein:

FIG. 1 is a schematic view of electronic apparatuses utilized in a synchronization method according to a preferred embodiment of the invention, wherein the slave apparatuses are being a screen wall;

FIG. 2 is a flowchart of the synchronization method according to the preferred embodiment of the invention;

FIG. 3 is a schematic view of electronic apparatuses utilized in a synchronization method according to a preferred embodiment of the invention, wherein the slave apparatuses are speakers; and

FIG. 4 is a schematic view of electronic apparatuses utilized in a synchronization method according to a preferred embodiment of the invention, wherein the slave apparatuses are speakers and a screen wall.

### DETAILED DESCRIPTION OF THE INVENTION

The present invention will be apparent from the following detailed description, which proceeds with reference to the accompanying drawings, wherein the same references relate to the same elements.

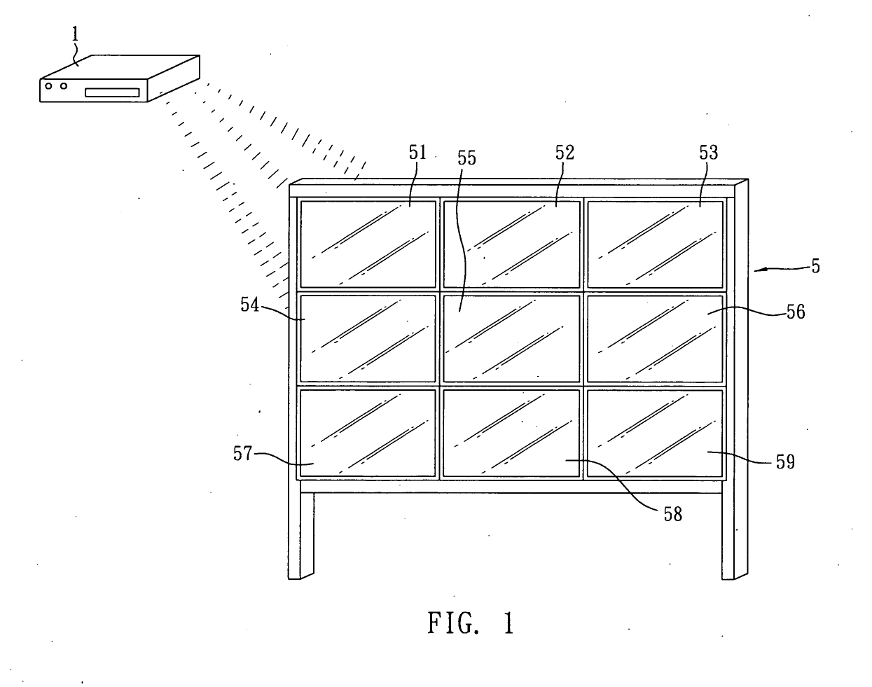

A synchronization method according to a preferred embodiment of the invention is cooperated with a master apparatus and a plurality of slave apparatuses. The master apparatus and the slave apparatuses are all electronic apparatuses. The maser apparatus provides data, and the slave apparatuses receive and play the data. In the embodiment, the maser apparatus can be a terminal apparatus (such as a computer) or a media source apparatus (such as a DVD player). The slave apparatus can be a media playing apparatus, such as a flat panel device (FPD), a speaker or a screen wall. As shown in FIG. 1, in the embodiment, the master apparatus is a DVD player 1, the slave apparatuses are being a screen wall 5, for example. The screen wall 5 is composed of nine display apparatuses 51 to 59 and each display apparatus serves as a slave apparatus.

In the embodiment, the DVD player 1I and the screen wall 5 are connected to build a network. The network can be a wired network or a wireless network. In the wired network, signals are transmitted through network lines. In the wireless network, signals are transmitted by wireless communication technologies, such as Bluetooth or Wi-Fi. The network of this embodiment is wireless network for example.

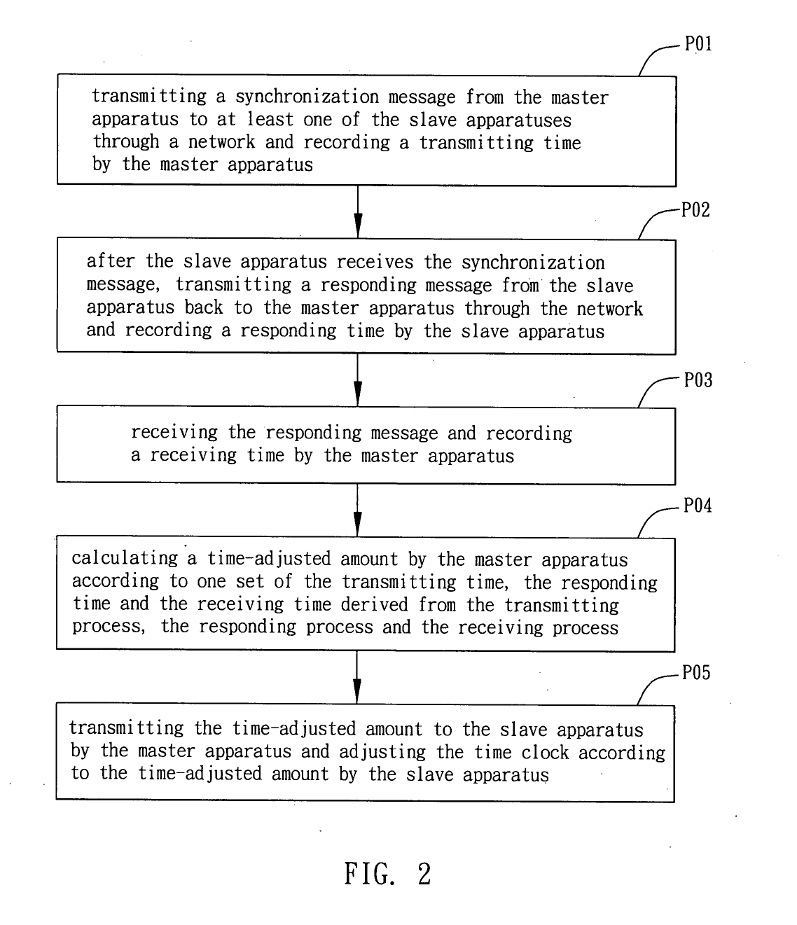

At first, the DVD player 1, the speakers 2 to 4 and the screen wall 5 must be synchronized, so that they can cooperate with each other well. As shown in FIG. 2, the synchronization method of the invention includes at least a transmitting process P01, at least a responding process P02, at least a receiving process P03, at least a calculating process P04 and at least a time-adjusting process P05.

The transmitting process POI is for transmitting a synchronization message from the master apparatus to at least one of the slave apparatuses through a network and recording a transmitting time by the master apparatus. Hereinbelow, the slave apparatus is, for example, the display apparatus 51. In the embodiment, the DVD player 1 transmits a synchronization message to the display apparatus 51 at a transmitting time Tm₀ and records the transmitting time Tm₀.

The responding process P02 is for, after the slave apparatus receives the synchronization message, transmitting a responding message from the slave apparatus back to the master apparatus through the network and recording a responding time by the slave apparatus. In the embodiment, after receiving the synchronization message, the display apparatus 51 transmits a responding message to the DVD player 1 at a responding time Tm₁ and records the responding time Tm₁. The synchronization method further comprises transmitting the responding time Tm₁ to the DVD player 1 by the display apparatus 51. In the embodiment, the responding time Tm₁ is transmitted to the DVD player 1 by the responding message. Please note that the transmitting time Tm₀ is obtained in the DVD player 1, and the responding time Tm₁ is obtained in the display apparatus 51.

The receiving process P03 is for receiving the responding message and recording a receiving time by the master apparatus. In the embodiment, the DVD player 1 receives the responding message at a receiving time Ts₁ and records the receiving time Ts₁.

The calculating process P04 is for calculating a time-adjusted amount by the master apparatus according to one set of the transmitting time, responding time and receiving time derived from the transmitting process, responding process and receiving process. After implementing the above mentioned transmitting process P01, the responding process P02 and the receiving process P03, the DVD player 1 can obtain a set of the transmitting time Tm₀, the responding time Tm₁ and the receiving time Ts₁, and then, according to them, calculate a time-adjusted amount dt. The time-adjusted amount dt satisfies the following condition:

$$dt = {Ts}_{1} - \frac{{Tm}_{1} + {Tm}_{0}}{2} \qquad ( Equation 1 )$$

The time-adjusting process P05 is for transmitting the time-adjusted amount to the slave apparatus by the master apparatus and adjusting the time clock according to the time-adjusted amount by the slave apparatus. In the embodiment, the DVD player 1 transmits the calculated time-adjusted amount dt to the display apparatus 51, and then the display apparatus 51 adjusts its time clock according to the time-adjusted amount dt. After the adjustment, the time of the display apparatus 51 will be the same as that of the DVD player 1. That is, the display apparatus 51 and the DVD player 1 are synchronized.

In the embodiment, the transmitting process P01, the responding process P02 and the receiving process P03 can be repeated several times and plural sets of the transmitting time, the responding time and the receiving time will be obtained. In this case, the synchronization method of the embodiment further comprises the steps of calculating the time difference between the transmitting time and the receiving time of each set by the DVD player 1, comparing the time differences to obtain a minimum time difference, selecting one of the sets of the transmitting time, the responding time and the receiving time corresponding to the minimum time difference by the DVD player 1, and calculating the time-adjusted amount according to the selected set of the transmitting time, the responding time and the receiving time by the DVD player 1. The foregoing steps are to obtain the time-adjusted amount when the network is more stable. According to the selected set of the transmitting time, the responding time and the receiving time, the time-adjusted amount can be calculated by the above mentioned equation 1.

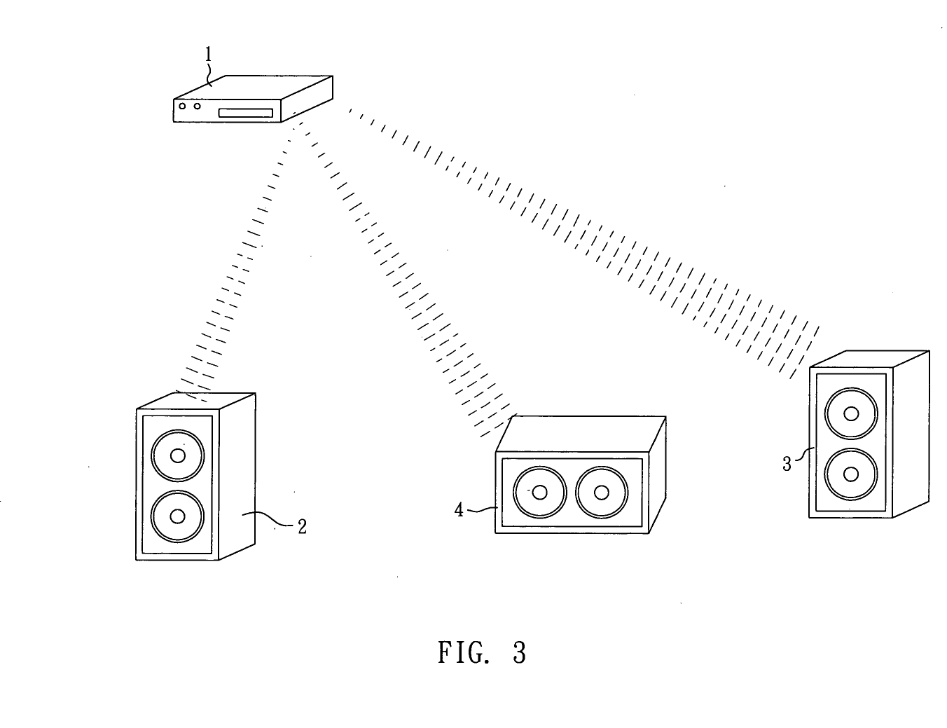

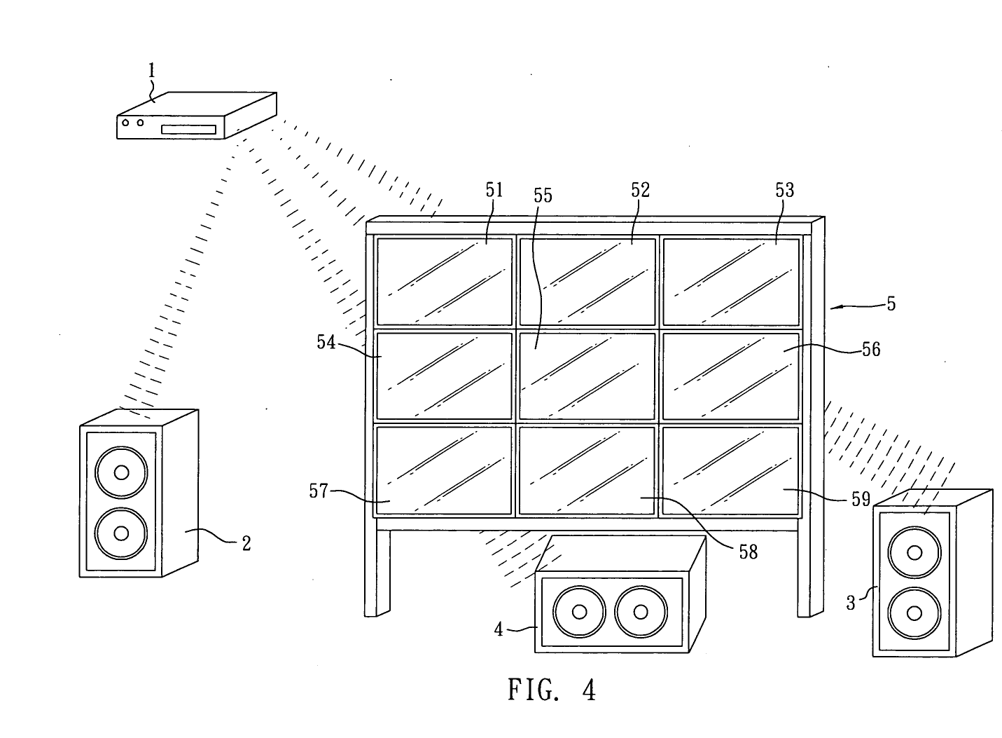

In the above description, the slave apparatus is the display apparatus 51 for example. Of course, by implementing the processes of the synchronization method of the invention, each of the display apparatuses 52 to 59 can obtain its time-adjusted amount and then adjust its time clock according to the individual time-adjusted amount. Besides, the slave apparatuses of the embodiment are not limited to being the screen wall 5, and they also can be other media playing apparatuses, such as speakers. As shown in FIG. 3, the slave apparatuses are the speakers 2 to 4, for example. Furthermore, the slave apparatuses are the speakers 2 to 4 and the screen wall 5 simultaneously, as shown in FIG. 4. By implementing the processes of the synchronization method of the invention, each of the speakers 2 to 4 and the display apparatuses 52 to 59 can obtain its time-adjusted amount and then adjust its time clock according to the individual time-adjusted amount. Therefore, the speakers 2 to 4 and the whole screen wall 5 can be synchronized with the DVD player 1. That is, the speakers 2 to 4 and the screen wall 5 have the same time clock with the DVD player 1. Then, the speakers 2 to 4 and the screen wall 5 can synchronously play the data outputted from the DVD player 1.

Before starting to play the data, the synchronization method further comprises a step of transmitting a data-setting message to the slave apparatus by the master apparatus so as to set the data to be played by the slave apparatus. In the embodiment, the DVD player 1 transmits a data-setting message to the speakers 2 to 4 and the display apparatuses 51 to 59 to specify the content to be played, such as the format of the data or the capacity of the data.

In addition, before starting to play the data, the synchronization method further comprises the steps of transmitting a prepare-to-start message to the slave apparatus by the master apparatus, conducting an initial operation after the slave apparatus receives the prepare-to-start message, and transmitting a preparation-completing message to the master apparatus after the slave apparatus completes the initial operation. In the embodiment, the DVD player 1 transmits a prepare-to-start message to the speakers 2 to 4 and the display apparatuses 51 to 59. After receiving the prepare-to-start message, the speakers 2 to 4 and the display apparatuses 51 to 59 conduct initial operations such as enabling a data buffer function. After completing initial operations, each of the speakers 2 to 4 and the display apparatuses 51 to 59 transmits a preparation-completing message to the DVD player 1.

After receiving the preparation-completing messages from the speakers 2 to 4 and the display apparatuses 51 to 59, the DVD player 1 transmits a start-to-play command and a start-to-play time to the speakers 2 to 4 and the display apparatuses 51 to 59. In the embodiment, the start-to-play command and a start-to-play time are enclosed in the same message. After receiving the start-to-play command and the start-to-play time, the speakers 2 to 4 and the display apparatuses 51 to 59 start to play the data at the start-to-play time. Therefore, the speakers 2 to 4 and the display apparatuses 51 to 59 can synchronously play the data.

After playing the data for a while, the speakers 2 to 4 and the display apparatuses 51 to 59 may loss synchronization. That is, the time of the speakers 2 to 4 and the display apparatuses 51 to 59 might become different. So the synchronization method of the invention, after playing the data for a while, further comprises a step of detecting whether the time of the slave apparatus is synchronous with that of the master apparatus or not. In the embodiment, the detecting step can be carried out by performing the transmitting process P01, the responding process P02, the receiving process P03 and the calculating process P04 to obtain the time-adjusted amount. When the calculated time-adjusted amount is zero, the slave apparatus and the master apparatus are synchronous. Alternatively, when the calculated time-adjusted amount is nonzero, the slave apparatus and the master apparatus are not synchronous, so that the slave apparatus must adjust its time clock according to the time-adjusted amount. Accordingly, the slave apparatus can be again synchronized with the master apparatus.

Furthermore, when the time of the slave apparatus is faster than that of the master apparatus, the slave apparatus will repeat a portion of the data. Alternatively, when the time of the slave apparatus is slower than that of the master apparatus, the slave apparatus will skip a portion of the data. Accordingly, all slave apparatuses can be adjusted to play the data synchronously.

When the user wants to implement some actions, such as “PAUSE”, “RESUME”, etc., while playing the data, the master apparatus and the slave apparatuses can conduct the desired actions synchronously. To achieve the above, the synchronization method of the embodiment further comprises the steps of transmitting an action message and an action time to the slave apparatus by the master apparatus, and conducting an action command, which is corresponding to the action message, at the action time by the master apparatus and the slave apparatus. In the embodiment, the action message is, for example, a pausing message, a resuming message or a stopping message.

As mentioned above, the synchronization method according to the invention is to calculate a time-adjusted amount according to at least one set of transmitting time, responding time and receiving time derived from the transmitting process, responding process and receiving process. Thus, the slave apparatus can adjust its time clock to be the same as that of the master apparatus according to the time-adjusted amount, so that the synchronization between the master apparatus and the slave apparatuses can be achieved. The synchronization method of the invention can be utilized in conjunction with the master apparatus and slave apparatuses so as to achieve the desired synchronization, further enhancing the playing efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A synchronization method cooperated with a master apparatus and a plurality of slave apparatuses, comprising:
at least a transmitting process for transmitting a synchronization message from the master apparatus to at least one of the slave apparatuses through a network and recording a transmitting time by the master apparatus;
at least a responding process for, after the slave apparatus receives the synchronization message, transmitting a responding message from the slave apparatus back to the master apparatus through the network and recording a responding time by the slave apparatus;
at least a receiving process for receiving the responding message and recording a receiving time by the master apparatus;
a calculating process for calculating a time-adjusted amount by the master apparatus according to at least one set of the transmitting time, the responding time and the receiving time derived from the transmitting process, the responding process and the receiving process; and
a time-adjusting process for transmitting the time-adjusted amount to the slave apparatus by the master apparatus and adjusting the time clock according to the time-adjusted amount by the slave apparatus.

2. The synchronization method as recited in claim 1, further comprising:
transmitting the responding time to the master apparatus by the slave apparatus.

3. The synchronization method as recited in claim 1, wherein the time-adjusted amount satisfies the following condition:
$$dt = {Ts}_{1} - \frac{{Tm}_{1} + {Tm}_{0}}{2}$$
wherein, dt is the time-adjusted amount, Ts₁ is the responding time, Tm₀ is the transmitting time, and Tm₁ is the receiving time.

4. The synchronization method as recited in claim 1, when there are plural sets of the transmitting time, the responding time and the receiving time, further comprising:
calculating the time difference between the transmitting time and the receiving time of each set by the master apparatus;
comparing the time differences to obtain a minimum time difference;
selecting one of the sets of the transmitting time, the responding time and the receiving time corresponding to the minimum time difference by the master apparatus; and
calculating the time-adjusted amount by the master apparatus according to the selected set of the transmitting time, the responding time and the receiving time by the master apparatus.

5. The synchronization method as recited in claim 4, wherein the time-adjusted amount satisfies the following condition:
$$dt = {Ts}_{1} - \frac{{Tm}_{1} + {Tm}_{0}}{2}$$
wherein, dt is the time-adjusted amount, Ts₁ is the responding time, Tm₀ is the transmitting time, and Tm₁ is the receiving time.

6. The synchronization method as recited in claim 1, further comprising:
transmitting a start-to-play command and a start-to-play time to the slave apparatus by the master apparatus; and
starting to play data at the start-to-play time by the slave apparatus.

7. The synchronization method as recited in claim 6, before starting to play the data, further comprising:
transmitting a data-setting message to the slave apparatus by the master apparatus to set the data to be played by the slave apparatus.

8. The synchronization method as recited in claim 6, before starting to play the data, further comprising:
transmitting a prepare-to-start message to the slave apparatus by the master apparatus;
conducting an initial operation after the slave apparatus receives the prepare-to-start message; and
transmitting a preparation-completing message to the master apparatus after the slave apparatus completes the initial operation.

9. The synchronization method as recited in claim 6, after playing the data, further comprising:
detecting whether time of the slave apparatus is synchronous with time of the master apparatus or not; and
repeating a portion of the data by the slave apparatus when the time of the slave apparatus is faster than the time of the master apparatus.

10. The synchronization method as recited in claim 6, after playing the data, further comprising:
detecting whether time of the slave apparatus is synchronous with time of the master apparatus or not; and
skipping a portion of the data by the slave apparatus when the time of the slave apparatus is slower than the time of the master apparatus.

11. The synchronization method as recited in claim 6, after playing the data, further comprising:
transmitting an action message and an action time to the slave apparatus by the master apparatus; and
conducting an action command at the action time by the master apparatus and the slave apparatus.

12. The synchronization method as recited in claim 1, wherein the network is a wired network or a wireless network.

13. The synchronization method as recited in claim 1, wherein the master apparatus is a terminal apparatus or a media source apparatus.

14. The synchronization method as recited in claim 1, wherein the slave apparatus is a media playing apparatus.
